(19) United States
(12) Patent Application Publication
(10) Pub. No.: US 2025/0379716 A1
(43) Pub. Date: Dec. 11, 2025

(54) GAIN VERSUS TIME CORRECTION USING PILOT SIGNALS

(71) Applicant: SKYWORKS SOLUTIONS, INC., Irvine, CA (US)

(72) Inventors: Grant Darcy Poulin, Carp (CA); Steven Russell Penney, Ottawa (CA); Boris Rubashkin, Ottawa (CA); Expeditus Pisico Jumarang, Ottawa (CA)

(21) Appl. No.: 19/224,409

(22) Filed: May 30, 2025

Related U.S. Application Data
(60) Provisional application No. 63/653,502, filed on May 30, 2024.

(51) Int. Cl. H04L 7/00; H04L 5/00

(52) U.S. Cl. CPC H04L 7/0016; H04L 5/0048; H04L 5/0098

(57) ABSTRACT

A device may apply a first signal to a device, the first signal comprising a long training field (LTF) and one or more data packets, the one or more data packets comprising one or more pilot tones. A device may demodulate the first signal. A device may compare power in the LTF to power of the one or more pilot tones. A device may determine gain vs. time based at least in part on comparing the power in the LTF to the power of the one or more pilot tones. A device may apply one or more corrections to the device based at least in part on the determined gain vs. time.

### CROSS-REFERENCE TO RELATED APPLICATION(S)

This application claims priority to U.S. Provisional Application No. 63/653,502 filed May 30, 2024, entitled GAIN VS. TIME CORRECTION USING PILOT SIGNALS, the disclosure of which is hereby expressly incorporated by reference herein in its entirety.

### BACKGROUND

### Field

The present disclosure relates to measuring gain vs. time in a wireless (e.g., Wi-Fi) signal.

### Description of the Related Art

In some power amplifiers, gain vs. time can be measured and/or applied to a correction circuit. The correction circuit can be configured to compensate and/or correct for gain vs. time changes.

### SUMMARY

In accordance with a number of implementations, the present disclosure relates to a method including: applying a first signal to a device, the first signal including a long training field (LTF) and one or more data packets, the one or more data packets including one or more pilot tones; demodulating the first signal; comparing power in the LTF to power of the one or more pilot tones; determining gain vs. time based at least in part on comparing the power in the LTF to the power of the one or more pilot tones; and applying one or more corrections to the device based at least in part on the determined gain vs. time.

In some aspects, the techniques described herein relate to a method wherein the first signal includes two or more subcarriers, and wherein demodulating the first signal involves demodulating each of the two or more subcarriers.

In some aspects, the techniques described herein relate to a method wherein demodulating the first signal involves determining amplitudes of the one or more pilot tones.

In some aspects, the techniques described herein relate to a method further including determining a difference between a first average amplitude of the LTF and a second average amplitude of the one or more pilot tones and determining gain vs. time based at least in part on the determined difference.

In some aspects, the techniques described herein relate to a method further including fusing the one or more corrections to the device.

In some aspects, the techniques described herein relate to a method further including measuring temperature at the device, wherein applying the one or more corrections to the device is based at least in part on the measured temperature.

In some aspects, the techniques described herein relate to a method wherein applying the one or more corrections involves modifying how quickly bias current increases at the device.

In some aspects, the techniques described herein relate to a method further including applying a second signal to the device and measuring differential error vector magnitude (DEVM) at the device based on the second signal to ensure correction of gain vs. time.

In some aspects, the techniques described herein relate to a method, further including measuring and reporting gain vs. time based on the second signal.

In accordance with some implementations of the present disclosure, the techniques described herein relate to a method including: applying a first signal to a device, the first signal including a long training field (LTF) and one or more pilot tones; demodulating the first signal; comparing power in the LTF to power of the one or more pilot tones; and applying one or more corrections to the device based at least in part on comparing power in the LTF to power of the one or more pilot tones.

In some aspects, the techniques described herein relate to a method wherein the first signal includes two or more subcarriers, and wherein demodulating the first signal involves demodulating each of the two or more subcarriers.

In some aspects, the techniques described herein relate to a method wherein demodulating the first signal involves determining amplitudes of the one or more pilot tones.

In some aspects, the techniques described herein relate to a method further including determining a difference between a first average amplitude of the LTF and a second average amplitude of the one or more pilot tones and determining gain vs. time based at least in part on the determined difference.

In some aspects, the techniques described herein relate to a method further including fusing the one or more corrections to the device.

In some aspects, the techniques described herein relate to a method further including measuring temperature at the device, wherein applying the one or more corrections to the device is based at least in part on the measured temperature.

In some aspects, the techniques described herein relate to a method wherein applying the one or more corrections involves modifying how quickly bias current increases at the device.

In some implementations of the present disclosure, a method includes: applying a first signal to an unfused device, the first signal including a long training field (LTF) and one or more pilot tones; demodulating the first signal; comparing power in the LTF to power of the one or more pilot tones; and fusing the device to apply one or more corrections based at least in part on comparing power in the LTF to power of the one or more pilot tones.

In some aspects, the techniques described herein relate to a method wherein the first signal includes two or more subcarriers, and wherein demodulating the first signal involves demodulating each of the two or more subcarriers.

In some aspects, the techniques described herein relate to a method wherein demodulating the first signal involves determining amplitudes of the one or more pilot tones.

In some aspects, the techniques described herein relate to a method further including determining a difference between a first average amplitude of the LTF and a second average amplitude of the one or more pilot tones and determining gain vs. time based at least in part on the determined difference.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates an example Wi-Fi orthogonal frequency-division multiplexing (OFDM) signal in accordance with one or more examples.

FIG. 2 illustrates an example preamble of a Wi-Fi signal in accordance with one or more examples.

FIG. 3 illustrates an example data portion of a Wi-Fi signal in accordance with one or more examples.

FIG. 4 provides a value plot illustrating amplitudes of subcarriers of signal packets over time.

FIG. 5 provides a graph illustrating EVM vs. gain droop.

FIG. 6 provides a graph illustrating subcarrier amplitude vs. subcarrier index for a wireless signal in accordance with one or more examples.

FIG. 7 provides a flowchart illustrating an example process for measuring EVM and/or DEVM of a signal in accordance with one or more examples.

FIG. 8 shows a block diagram of a wireless system that includes an antenna architecture having one or more features as described herein.

### DESCRIPTION

The headings provided herein, if any, are for convenience only and do not necessarily affect the scope or meaning of the claimed invention.

In Wi-Fi and/or other wireless systems, it can be advantageous to control transmit gain vs. time to avoid Error Vector Magnitude (EVM) and/or differential EVM (DEVM) degradation due to transmit power changes that can occur over the duration of a packet. In some power amplifiers, gain vs. time can be measured and/or applied to a correction circuit. The correction circuit can be configured to compensate and/or correct for gain vs. time changes.

In some examples, corrections can be performed at a final test using automatic test equipment (ATE). For example, a tester can measure gain vs. time, determine what corrections are required to compensate for gain changes, and/or adjust the gain correction circuit appropriately. Corrections and/or adjustments can be applied using fuses in the gain correction circuit.

Given that gain vs. time may need to be measured accurately (e.g., within tenths or hundredths of a decibel), gain vs. time may normally be averaged over at least 10 sweeps in time. Each sweep may be at least 5 ms long, with at least 10 ms off time before each sweep to allow the power amplifier to cool down to an initial state. As a result, measuring gain vs. time can be a long measurement, increasing test time and test cost.

Examples described herein can advantageously provide improved methods and/or systems for measuring gain vs. time using pilot tones and/or signals embedded in a wireless (e.g., Wi-Fi) signal. In using the embedded pilot signals, it may be possible to extract gain vs. time essentially at minimal test time and/or test cost. Such examples can provide a more accurate system for measuring gain vs. time with a pulsed continuous wave signal. For example, given that pilot signals are used in Wi-Fi signals, re-using the obtained pilot signals may obviate requirements to obtain additional signals and/or measurements. While examples are described herein in the context of Wi-Fi signals, this is for exemplary purposes and the systems and/or methods described herein may be applied to other wireless signals.

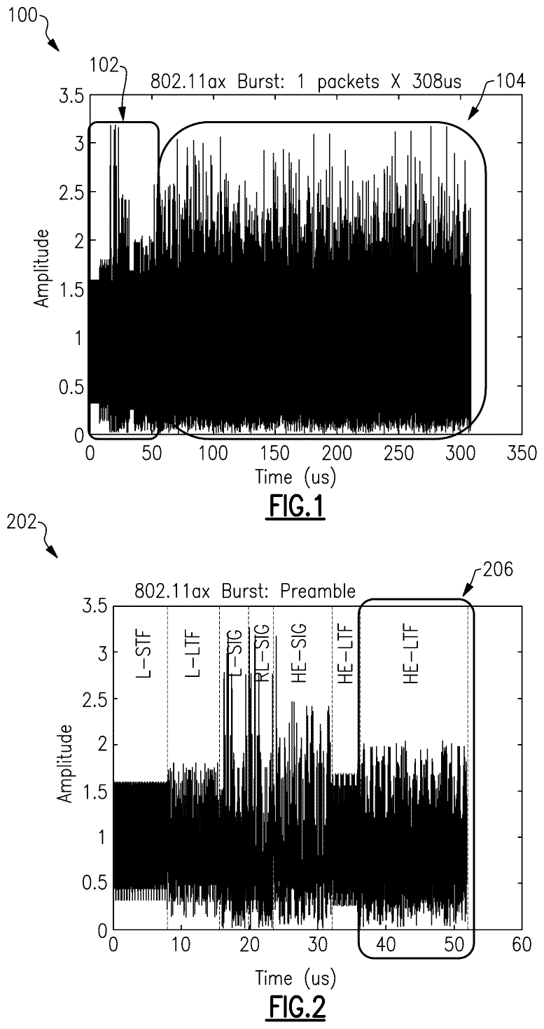

FIG. 1 illustrates an example Wi-Fi orthogonal frequency-division multiplexing (OFDM) signal 100 in accordance with one or more examples. The signal 100 may comprise a preamble 102 and/or a data portion 104. The preamble 102 may comprise subcarriers indicating data rate, tones, and/or other features of the data portion 104.

FIG. 2 illustrates an example preamble 202 of a Wi-Fi signal in accordance with one or more examples. The preamble 202 can contain a plurality of calibration segments. The plurality of calibration segments can include a Long Training Field 206 (LTF; e.g., HE-LTF in 802.11ax, or EHT-LTF in 802.11be). The LTF 206 may be used as a reference signal and/or other data packets of a signal may be measured relative to the LTF 206. A magnitude of each subcarrier in the LTF 206 may be defined in a standard and/or a magnitude of each subcarrier in each data symbol in the remainder of the packet may be measured relative to amplitudes of each subcarrier in the LTF 206.

The LTF 206 may indicate magnitude and/or phase of subcarriers (including pilot subcarriers/tones) of the associated data portion. The preamble 202 may be utilized in demodulating the data portion.

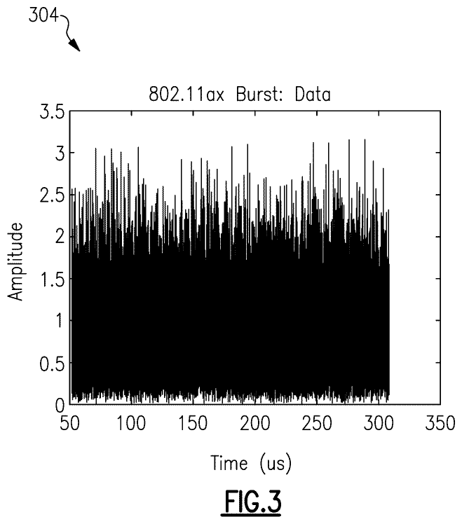

FIG. 3 illustrates an example data portion 304 of a Wi-Fi signal in accordance with one or more examples. The data portion 304 can comprise a plurality of packets (e.g., sixteen packets) having a common length (e.g., 16 μs).

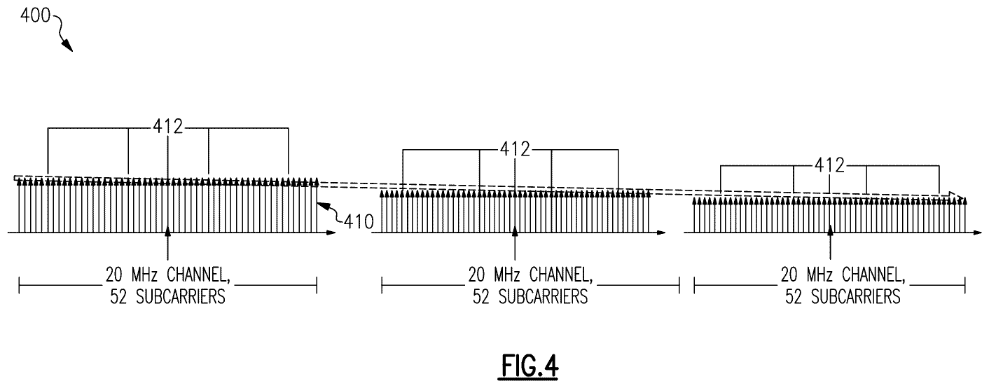

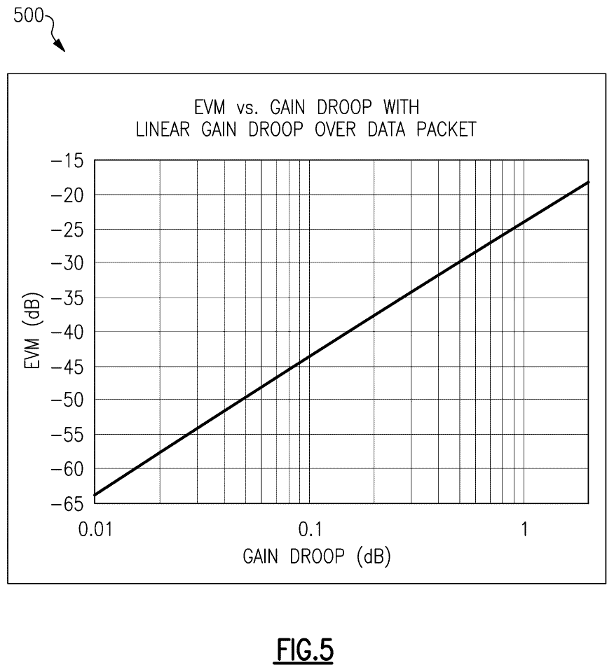

FIG. 4 provides a value plot illustrating amplitudes of subcarriers 410 of signal packets 400 over time. If the gain of a power amplifier changes with time, then the amplitude of subcarriers 410 later in each packet will be lower than they were during the preamble and/or or early in the packet. Thus, the amplitudes of the subcarriers 410 can droop over the packet 400 (e.g., a 5 ms packet). This can result in EVM degradation.

If the amplitude of an OFDM signal changes over time (e.g., due to heating of the power amplifier), when the signal is demodulated, the amplitude of each demodulated subcarrier may no longer be the same as it was in the preamble. This results in EVM degradation, where demodulated subcarriers appear to get progressively closer to the origin later in the packet.

Each packet 400 can comprise one or more pilot signals 412 and/or tones. The pilot signals 412 can be distributed throughout each packet 400. The pilot signals 412 may experience droop and/or degradation along with other subcarriers 410 of the packets 400.

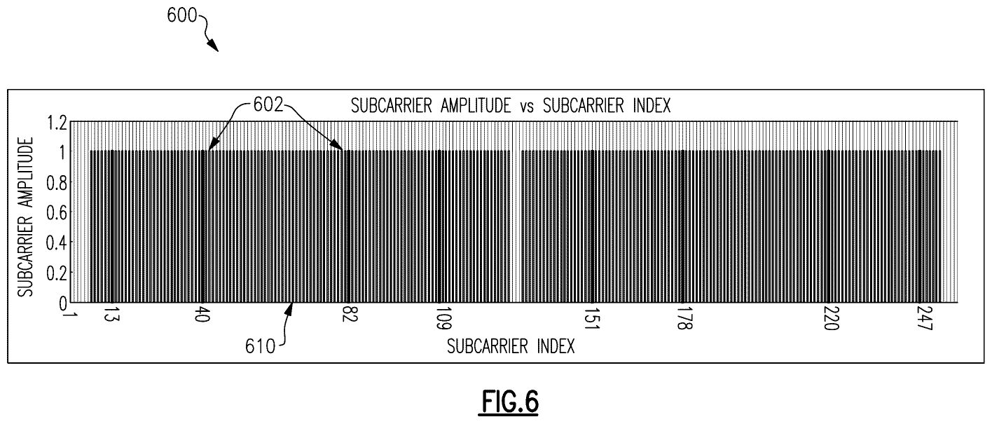

FIG. 5 provides a graph 500 illustrating EVM vs. gain droop. If there is a gain droop of 0.7 dB over a 5 ms long packet, the resulting EVM may be approximately −27 dB. It may be advantageous to achieve EVM less than −50 dB. Achieving such low levels of gain variation vs. time may require analog compensation circuitry.

FIG. 6 provides a graph 600 illustrating subcarrier amplitude vs. Wi-Fi signals can include pilot subcarriers 602 (i.e., pilot signals and/or tones). For example, a 20 MHz 802.11ax signal may include two-hundred and fifty-six total subcarriers 610, fourteen unused subcarriers, eight pilot subcarriers 602 distributed across the channel, and/or two-hundred and thirty-four data carrying subcarriers.

Pilot subcarriers 602 can have a known magnitude and phase. In some cases, pilot subcarriers 602 have the same average power as the power in the preamble and/or in each symbol. If the gain of the power amplifier drops versus time, then power of the pilot subcarriers 602 may also drop. By measuring the amplitude of the pilot subcarriers 602 versus time, the gain of the power amplifier vs. time can be accurately determined.

Measuring gain vs. time through use of pilot subcarriers 602 can be advantageous over other methods. For example, some methods involve applying a continuous wave (CW) signal and/or measuring the gain vs. time of the signal with a dedicated measurement. However, given that gain vs. time is noisy, it may require taking an average of multiple measurement, which may result in an excessive time to achieve an accurate measurement of gain vs. time.

An exact time where the reference gain should be measured may not be well defined when using a CW signal. The 802.11ax standard determines the amplitude of the reference by measuring the LTF over a 16 μs time interval, and then performs a Fast Fourier Transform (FFT) of the signal. By using a CW signal, a specific time at which to measure the reference gain must be chosen, and this is prone to error.

CW signals can have much different properties than modulated OFDM signals. As a result, gain vs. time measurements with CW signals may have a significant error compared to what would be seen with a modulated signal. Practically, gain vs. time can be difficult to measure more than once, since it is a dedicated measurement. It may not be possible to measure gain vs. time for other frequencies and/or at other powers.

Using pilot subcarriers 602 to compute gain vs. time can have a number of advantages. For example, because the pilot subcarriers 602 may be demodulated along with the OFDM signal, no extra time and/or cost. The pilot subcarriers 602 are a subset of the subcarriers of the signal and are therefore available without any additional computation. Using the LTF of the signal for reference and/or using pilot subcarriers 602 for determining gain vs. time measures exactly like a receiver. Moreover, use of pilot subcarriers 602 can remove any ambiguity of when the reference and/or pilot amplitudes should be measured.

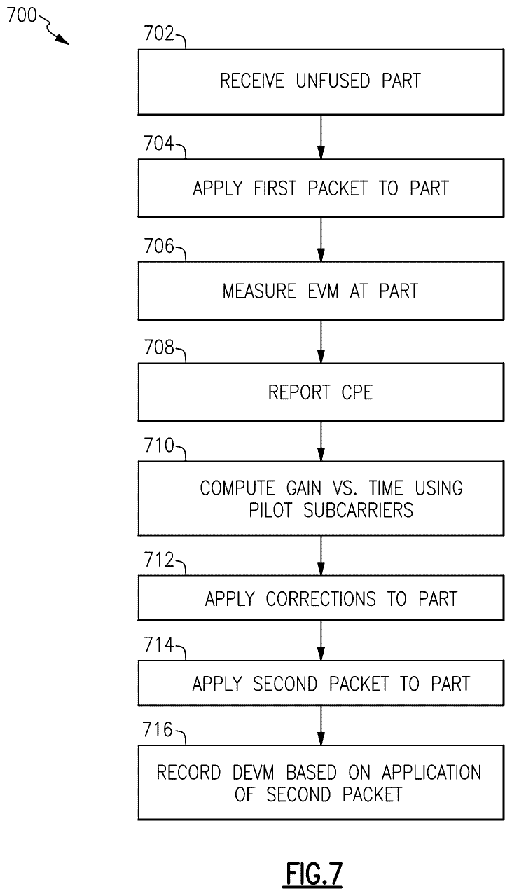

FIG. 7 provides a flowchart illustrating an example process 700 for measuring EVM and/or DEVM of a signal in accordance with one or more examples. Steps of the process 700 may be performed using any suitable device(s), including automated test equipment.

At a step 702, the process 700 involves receiving an unfused part (e.g., a power amplifier and/or other device).

At a step 704, the process 700 involves applying a first signal and/or packet to the part. For example, the packet can comprise a 5 ms long, 20 MHz bandwidth 802.11be packet. A 5 ms long packet may comprise approximately three-hundred symbols, with each symbol approximately 16 μs long.

At a step 706, the process 700 involves demodulating and/or measuring EVM of the part. When measuring EVM of the part, each subcarrier may be demodulated. Accordingly, amplitudes of pilot subcarriers of the signal may be determined during demodulation.

Some receivers may report a difference between an average amplitude of the LTF and an average power of the pilots in each symbol. This metric is sometimes called Common Pilot Error (CPE). If available, the process 700 involve reporting the CPE at a step 708. If CPE is not available, a step 710 involves computing gain vs time by comparing the average power in the LTF with the average power of the pilot subcarriers in each symbol.

Once CPE and/or gain vs. time is determined, a step 712 involves using CPE and/or gain vs. time to apply an appropriate analog correction and/or fusing in these settings. It may not be necessary to go back and test DEVM for the first signal again, rather, correct fusing of gain vs. time can be verified when DEVM is measure at a second signal.

Fusing may involve measuring gain vs. time to determine settings to apply to the part and/or hardwiring any determined setting into the part. In some examples, temperature measurements may be used in determining the settings and/or corrections to apply to the part.

Settings and/or changes can include modifying how quickly bias current increases. In some examples, the part and/or a circuit of the part may have a programmable function to correct how bias may be applied to EVM. Bias may be adjusted to counteract damage from heating at the part.

At a step 714, the process 700 involves applying a second signal and/or packet to the part. For example, the second signal may comprise a 5 ms long, 80 MHz 802.11be signal.

At a step 716, DEVM may be recorded to verify that the fusing of the part was correct. In some examples, gain vs. time can reported a second time, however doing so may not be required.

In some embodiments, an antenna architecture having one or more features as described herein can be implemented in a device, a facility, and/or a system that utilizes beam tilting functionality. In some embodiments, such a device, facility and/or system can be configured to provide 5G functionality.

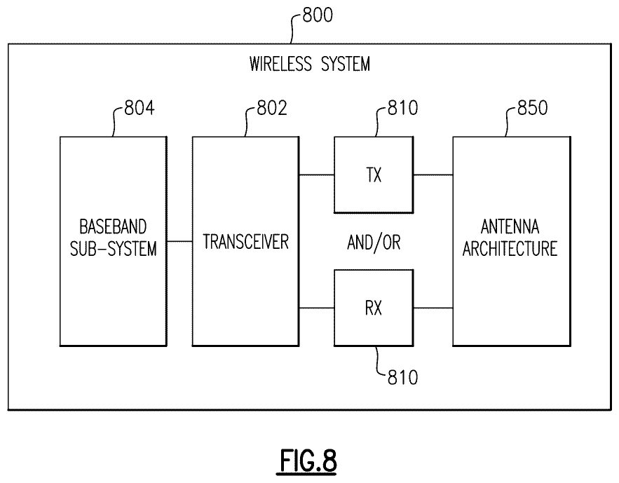

For example, FIG. 8 shows a block diagram of a wireless system 800 that includes an antenna architecture 850 having one or more features as described herein. Such an antenna architecture can be operatively with a transceiver 802 through either or both of a transmit circuit 810 (e.g., including a power amplifier) and a receive circuit 810 (e.g., including a low-noise amplifier). The transceiver 802 can be in communication with a baseband sub-system 804 that is configured to process digital and/or analog signals.

In some embodiments, substantially all of the wireless system 800 can be implemented within a base station such as a cellular base station. In some embodiments, substantially all of the wireless system 800 can be implemented within a mobile device.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Description using the singular or plural number may also include the plural or singular number, respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
applying a first signal to a device, the first signal comprising a long training field (LTF) and one or more data packets, the one or more data packets comprising one or more pilot tones;
demodulating the first signal;
comparing power in the LTF to power of the one or more pilot tones;
determining gain vs. time based at least in part on comparing the power in the LTF to the power of the one or more pilot tones; and
applying one or more corrections to the device based at least in part on the determined gain vs. time.

2. The method of claim 1 wherein the first signal comprises two or more subcarriers, and wherein demodulating the first signal involves demodulating each of the two or more subcarriers.

3. The method of claim 1 wherein demodulating the first signal involves determining amplitudes of the one or more pilot tones.

4. The method of claim 1 further comprising determining a difference between a first average amplitude of the LTF and a second average amplitude of the one or more pilot tones and determining gain vs. time based at least in part on the determined difference.

5. The method of claim 1 further comprising fusing the one or more corrections to the device.

6. The method of claim 1 further comprising measuring temperature at the device, wherein applying the one or more corrections to the device is based at least in part on the measured temperature.

7. The method of claim 1 wherein applying the one or more corrections involves modifying how quickly bias current increases at the device.

8. The method of claim 1 further comprising applying a second signal to the device and measuring differential error vector magnitude (DEVM) at the device based on the second signal to ensure correction of gain vs. time.

9. The method of claim 8, further comprising measuring and reporting gain vs. time based on the second signal.

10. A method comprising:
applying a first signal to a device, the first signal comprising a long training field (LTF) and one or more pilot tones;
demodulating the first signal;
comparing power in the LTF to power of the one or more pilot tones; and
applying one or more corrections to the device based at least in part on comparing power in the LTF to power of the one or more pilot tones.

11. The method of claim 10 wherein the first signal comprises two or more subcarriers, and wherein demodulating the first signal involves demodulating each of the two or more subcarriers.

12. The method of claim 10 wherein demodulating the first signal involves determining amplitudes of the one or more pilot tones.

13. The method of claim 10 further comprising determining a difference between a first average amplitude of the LTF and a second average amplitude of the one or more pilot tones and determining gain vs. time based at least in part on the determined difference.

14. The method of claim 10 further comprising fusing the one or more corrections to the device.

15. The method of claim 10 further comprising measuring temperature at the device, wherein applying the one or more corrections to the device is based at least in part on the measured temperature.

16. The method of claim 10 wherein applying the one or more corrections involves modifying how quickly bias current increases at the device.

17. A method comprising:
applying a first signal to an unfused device, the first signal comprising a long training field (LTF) and one or more pilot tones;
demodulating the first signal;
comparing power in the LTF to power of the one or more pilot tones; and
fusing the device to apply one or more corrections based at least in part on comparing power in the LTF to power of the one or more pilot tones.

18. The method of claim 17 wherein the first signal comprises two or more subcarriers, and wherein demodulating the first signal involves demodulating each of the two or more subcarriers.

19. The method of claim 17 wherein demodulating the first signal involves determining amplitudes of the one or more pilot tones.

20. The method of claim 17 further comprising determining a difference between a first average amplitude of the LTF and a second average amplitude of the one or more pilot tones and determining gain vs. time based at least in part on the determined difference.
